(19) United States
(12) Patent Application Publication
(10) Pub. No.: US 2011/0040911 A1
(43) Pub. Date: Feb. 17, 2011

(54) DUAL INTERFACE COHERENT AND NON-COHERENT NETWORK INTERFACE CONTROLLER ARCHITECTURE

(76) Inventors: Anil Vasudevan, Portland, OR (US); Parthasarathy Sarangam, Portland, OR (US); Sujoy Sen, Portland, OR (US); Gary Tsao, Austin, TX (US); Dave B. Minturn, Hillsboro, OR (US)

Correspondence Address: INTEL CORPORATION;c/o CPA Global, P.O. BOX 52050, MINNEAPOLIS, MN, 55402, US

(21) Appl. No.: 12/540,545

(22) Filed: Aug. 13, 2009

(51) Int. Cl. G06F 13/00; G06F 12/08

(52) U.S. Cl. 710/100; 711/146; 711/E12.033

(57) ABSTRACT

A dual interface coherent and non-coherent network interface controller architecture is generally presented. In this regard, a network interface controller is introduced including a non-coherent bus interface to communicatively couple with devices of a system through a non-coherent protocol, the non-coherent bus interface to facilitate discovery of the network interface controller by an operating system, a coherent bus interface to communicatively couple with devices of the system through a coherent protocol, and a coherency engine to perform coherent transactions over the coherent interface including to snoop for writes on system memory. Other embodiments are also disclosed and claimed.

### FIELD

This invention relates to the field of computer systems and, in particular, to a dual interface coherent and non-coherent network interface controller architecture.

### BACKGROUND

As computer systems advance, the input/output (I/O) capabilities of computers become more demanding. A typical computer system has a number of I/O devices, such as network interface controllers (NICs), universal serial bus controllers, video controllers, PCI devices, and PCI express devices, that facilitate communication between users, computers, and networks. Yet, to support the plethora of operating environments that I/O devices are required to function in, developers often create software device drivers to provide specific support for each I/O device.

Traditionally NICs are architected with a non-coherent interface like the one offered though an I/O bus e.g. Peripheral Component Interconnect Express (PCI-E). A device driver would need to use this non-coherent interface to write to device registers on the NIC, for example to alert the NIC that data needs to be transmitted over the network. The communication delay between an application and the NIC can be substantial. As NICs approach 100 Gb/s, optimizing interfaces to communicate between hardware and software are necessary to keep the system balanced with respect to available resources. To put this in perspective, the arrival rate for a standard ethernet frame 1518 bytes at 100 Gb/s is once every ˜120 ns, which is close to the data rate for a 128 byte frame at 10 Gb/s and within the range of latencies to memory from a CPU i.e. the data rates for full size frames is approaching small packet data rates, which traditionally has always challenged network interface design.

### BRIEF DESCRIPTION OF THE DRAWINGS

The present invention is illustrated by way of example and not intended to be limited by the figures of the accompanying drawings.

FIG. 1 is a block diagram of an example system suitable for implementing a dual interface network interface controller, in accordance with one example embodiment of the invention;

FIG. 2 is a block diagram of an example dual interface network interface controller, in accordance with one example embodiment of the invention;

FIG. 3 is a flow chart of an example method for implementing a coherency engine, in accordance with one example embodiment of the invention;

FIG. 4 is a flow chart of an example method for processing outgoing network data over a coherent bus, in accordance with one example embodiment of the invention;

FIG. 5 is a flow chart of an example method for processing received network data over a coherent bus, in accordance with one example embodiment of the invention;

FIG. 6 is a flow chart of an example method of an egress port flow for forwarding data, in accordance with one example embodiment of the invention;

FIG. 7 is a flow chart of an example method of an ingress port flow for forwarding data, in accordance with one example embodiment of the invention;

FIG. 8 is a flow chart of an example method of a processor configuration flow for forwarding data, in accordance with one example embodiment of the invention; and

FIG. 9 is a block diagram of an example storage medium including content which, when accessed by a device, causes the device to implement one or more aspects of one or more embodiment(s) of the invention.

### DETAILED DESCRIPTION

In the following description, numerous specific details are set forth such as specific I/O devices, monitor table implementations, cache states, and other details in order to provide a thorough understanding of the present invention. It will be apparent, however, to one skilled in the art that these specific details need not be employed to practice the present invention. In other instances, well known components or methods, such as well-known caching schemes, processor pipeline execution architecture, and interconnect protocols have not been described in detail in order to avoid unnecessarily obscuring the present invention.

The apparatus and method described herein are for a dual interface coherent and non-coherent network interface controller architecture. It is readily apparent to one skilled in the art, that the method and apparatus disclosed herein may be implemented in any system having coherent and non-coherent buses. As an alternative, the method and apparatus described herein may be applied to multiple I/O devices, and need not be limited to network interface controllers.

FIG. 1 is a block diagram of an example system suitable for implementing a dual interface network interface controller, in accordance with one example embodiment of the invention. As shown, system 100 includes processors 102, input/output controller 104, system memory 106, coherent bus 108, first dual interface network controller (DNIC) 110, second DNIC 112, input/output devices 114, non-coherent bus 116, device registers 118, data 120, and application buffer 122.

Processors 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect. In one embodiment, processors 102 are Intel® compatible processors. Processors 102 may have an instruction set containing a plurality of machine level instructions that may be invoked, for example by an application or operating system.

Input/output (I/O) controller 104 may represent any type of chipset or control logic that interfaces I/O device(s) 114 with the other components of system 100. In one embodiment, I/O controller 104 may be referred to as a south bridge. In another embodiment, I/O controller 104 implements non-coherent bus 116, which may comply with the Peripheral Component Interconnect (PCI) Express™ Base Specification, Revision 1.0a, PCI Special Interest Group, released Apr. 15, 2003.

System memory 106 provides storage for system 100 that is coherent among devices coupled with coherent bus 108. In one embodiment, coherent bus 108 represents a QuickPath Interconnect bus. System memory 106 may store cache lines that are maintained and/or monitored by devices of system 100. For example system memory 106 may store device registers 118, which may control the function of DNICs 110 and 112, data 120, which may be a private data store, and application buffer 122, which may store data or instructions used by an application running on processors 102.

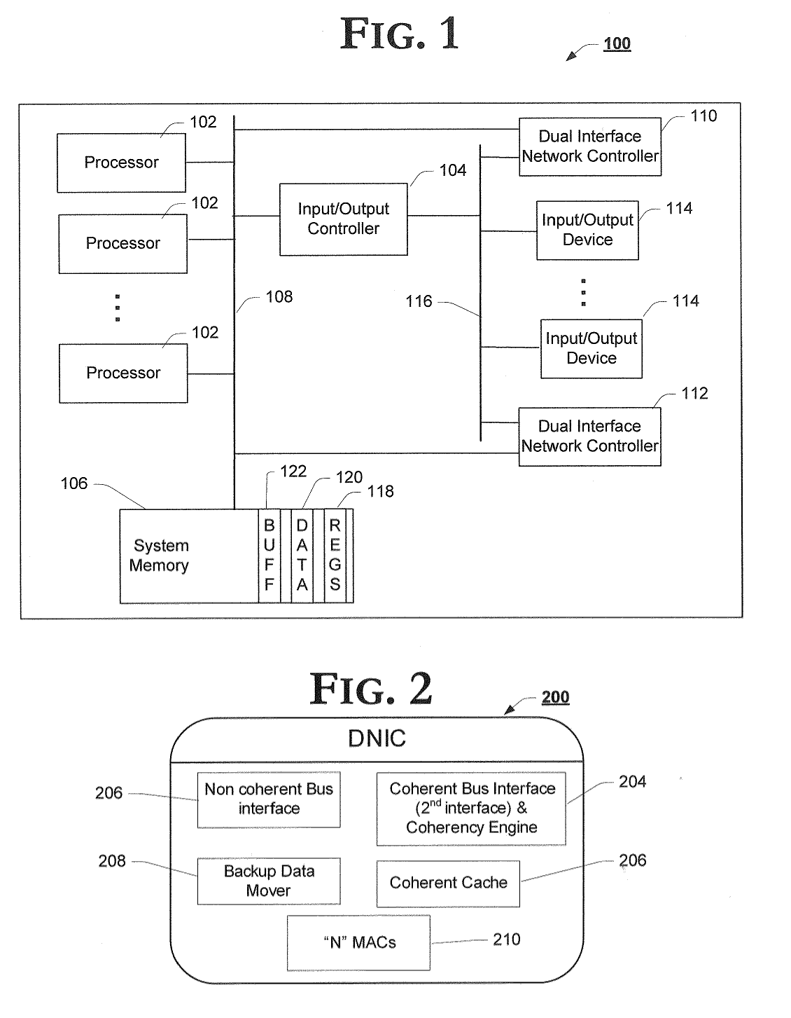

DNICs 110 and 112 may represent any type of device that allows system 100 to communicate with other systems or devices. DNICs 110 and 112 interface with both coherent bus 108 and non-coherent bus 116 and may have an architecture as described in more detail below in reference to FIG. 2.

Input/output (I/O) devices 114 may represent any type of device, peripheral or component that provides input to or processes output from system 100.

FIG. 2 is a block diagram of an example dual interface network interface controller, in accordance with one example embodiment of the invention. As shown, DNIC 200 includes non-coherent bus interface 202, coherent bus interface & coherency engine 204, coherent cache 206, backup data mover 208 and media access controls (MACs) 210.

Non-coherent bus interface 202 interfaces DNIC 200 with devices of a system over a non-coherent bus, for example non-coherent bus 116. Non-coherent bus interface 202 may be used to transfer data primarily when a coherent bus is not able to transfer data, or is unavailable, and for legacy support, for example to facilitate discovery of DNIC 200 during an operating system scan.

Coherency engine 204 implements the cache coherency protocol of the coherent bus, for example bus 108, and monitors/maintains a set of cache lines that DNIC 200 uses to implement data movement optimizations, for example coherency engine 204 may snoop on device registers 118 in system memory 106. In one embodiment, when an address is provided to coherency engine 204 to monitor, coherency engine 204 issues on its coherent interface a request to own the cache lines corresponding to the addresses it wishes to monitor. It is not necessary for DNIC 200 to bring the data in and store it in coherent cache 206 for every line it is monitoring—at any given point in time, coherency engine 204 monitors many more cache lines than lines it has actual data for, something it can do by virtue of being a caching agent. The monitoring is accomplished with an internal map that the coherency engine uses to keep track of “cache lines of interest.” Once it receives ownership of the line coherency engine 204 notifies the caller prior to any action being taken by DNIC 200. An example of mapping cache lines of interest can be found in U.S. patent application Ser. No. 11/026,928, filed on Dec. 29, 2004, which is herein incorporated by reference.

DNIC 200 then proceeds to perform a transmit or receive operation on these addresses. Once those operations are complete, coherency engine 204 releases ownership. The specific actions to be taken on the coherent domain for this is implementation dependent e.g. if the lines were stored in coherent cache 206 and were globally visible.

DNIC 200 may contain coherent cache 206 that participates in cache coherency. DNIC 200 uses this cache to selectively store shared data structures between the host and DNIC 200. This enables the host to notify DNIC 200 as soon as it has work to do, unlike in the existing non-coherent architecture, where such notifications are typically implemented through uncached (UC) or write combined (USWC) writes, which serializes the data flow on the CPU.

Backup data mover 208 enables DNIC 200 to implement a “no memory pinning” policy for data transfer operations. Backup data mover 208 is used to protect against user data buffers being paged out, before DNIC 200 performs any needed operations with these buffers. As an example, when a buffer, say buffer 122, is prepared for a transmit operation, its address and length are provided to coherency engine 204. Coherency engine 204 requests for the lines corresponding to these addresses and adds them to the lists of lines that it is actively monitoring. These user buffers could be paged out, because in one embodiment these buffers are not pinned in memory or copied into non-paged kernel buffers. If these lines get paged out, coherency engine 204 would know, because it would get requests for them. If coherency engine 204 gets requests for these lines before it has performed its operations on them, e.g. transmit the data on the wire, backup data mover 208 copies data from these lines into a pre-allocated private memory data store, for example data 120, which may be used only when user level buffers get paged out.

MACs 210 represent a plurality of network ports, although the invention can be practiced with just a single network port. MACs 210 may include wired and/or wireless channels. In one embodiment, MACs 210 include network ports of different protocols, for example, but not limited to Ethernet, FDDI, ATM, Token ring, or Frame relay.

FIG. 3 is a flow chart of an example method for implementing a coherency engine, in accordance with one example embodiment of the invention. Method 300 begins when a device driver creates a descriptor (302) and fills it with control information about an operation to perform as well as with an address on which this operation should occur e.g. where to put the data into, or where to get the data from.

The DNIC device meanwhile, monitors (304) the address of the next descriptor that the driver is likely to write on each queue that it exposes to the host. The act of the driver creating the descriptor and filling it with info (which it has to do anyways), results in snoop transactions being issued by the processor to get ownership of the cache line associated with the address of the descriptor. Since the DNIC is monitoring these lines via its coherency engine 204, it is notified about this access (306). The DNIC now knows that it has work to do, and accesses (308) the descriptor and performs specified operations.

One skilled in the art would appreciate that method 300 eliminates the need for a separate register on the NIC as well as an un-cached or write combining (UC or USWC) write to a device register. Constantly updating the device register degrades performance, but with this flow, eliminating this register access permits the SW to notify as often as it needs to without any impact on performance.

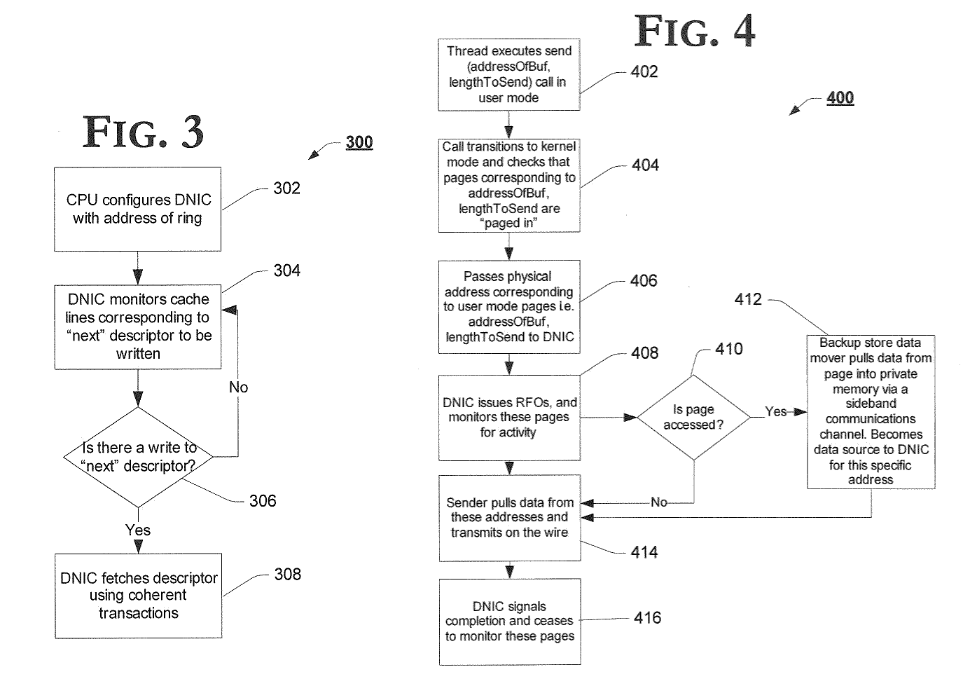

FIG. 4 is a flow chart of an example method for processing outgoing network data over a coherent bus, in accordance with one example embodiment of the invention. Method 400 begins with an application issuing a send call (402) that semantically appears as follows send (address of data to send, length of data to send). In a traditional data flow the data is either i) copied into a kernel buffer (404) or, ii) the page corresponding to the address is pinned in memory.

After either of these operations, the address of the copied buffer or the pinned memory is provided to the NIC. Either of these operations are expensive and consume system resources e.g. memory bandwidth, CPU time. In a DNIC architecture, this flow is optimized as follows: the send ( ) call passes the “address of data to send” and “length of data to send” to the device (406). The device, keeps track of the address, and on its coherent link (108), issues an intent to access (408) physical addresses represented by “address of data to send.” The specific mode that the device chooses to access the line i.e. whether it is for exclusive ownership of cache lines that are represented by these addresses or shared ownership or other modes is implementation dependent.

Once the device gets ownership of the line, it is not necessary for the device to store the data in its cache. The device however, does need to keep track of the fact that it had solicited and has been granted access to cache lines corresponding to physical addresses that contain application data to be transmitted.

The device notifies the caller upon receiving ownership of these lines. Subsequently the device transmits (414) the data. Upon transmit completion, the device notifies (416) the sender.

Between steps (408) and (414) if the user buffer gets paged out (410), the backup data mover 208 is activated (412) and the data is stored in some other temporary memory that is specifically allocated for this purpose, from which it is transmitted. The backup data mover ensures that the data is moved into temporary memory before any paging out operation starts.

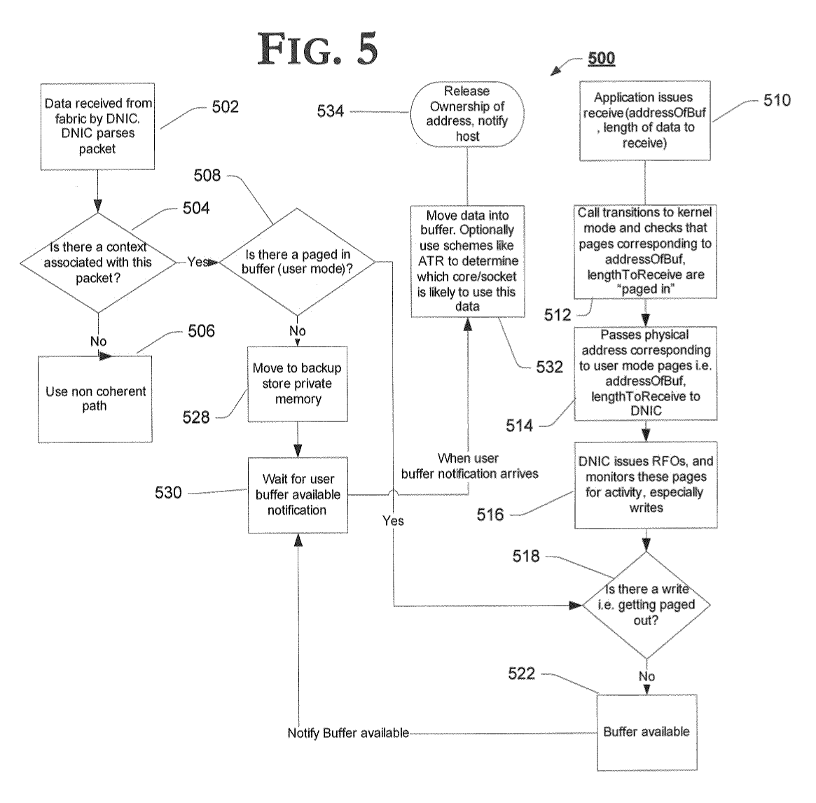

FIG. 5 is a flow chart of an example method for processing received network data over a coherent bus, in accordance with one example embodiment of the invention. The receive flow 500 includes the following sequence of operations:

Data received (502) by the DNIC would be parsed, and if there is a context associated with the packet (504) the coherent interface would be used. Otherwise, the non-coherent interface would be used (506).

When a user mode receive buffer is posted (510), after the call transitions to kernel mode (512) its address is handed down to the device (514). The device requests for ownership of these lines and maintains it in its internal monitoring map (516).

If (518) this memory is not paged out (522), when a packet arrives for this receive buffer, the DNIC's Receive Side Coalescing (RSC) logic would place the data into this buffer (532). In order to do this, the sockets context, for a sockets based application would have to be shared with the device. The DNIC would access this context and determine the offsets e.g. for TCP based on sequence numbers.

In the event there is no receive buffer posted (508), the DNIC puts the incoming data, into private, memory, that is pre allocated for this purpose and provided to the DNIC (528). When a buffer is eventually posted for the data received (530), the DNIC asserts ownership of these lines per (i) and updates these buffers with data in its private memory. Optionally the DNIC uses application targeted routing (ATR), as described in U.S. patent application Ser. No. 11/864,645, filed on Sep. 28, 2007, which is herein incorporated by reference, to have the data on the core that the thread is running on. When completed the DNIC releases ownership (534) of the address and notifies the host.

If during the course of updates, a page fault occurs on these user buffers, which causes an access to these physical addresses, data is returned from lines in private memory, assuming they exist. If they do not exist, then it is noted as such. Later on, when data arrives, the OS is informed about the missing page, and the page fault handler is invoked, similar to certain advanced graphics I/O designs.

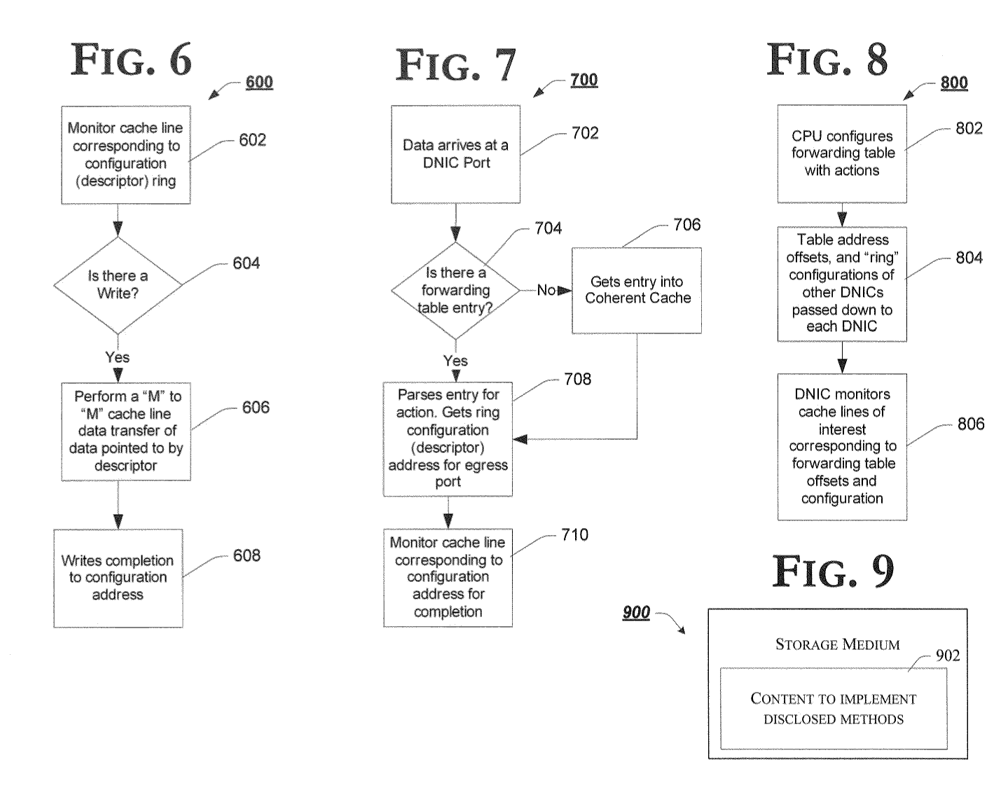

FIGS. 6, 7 and 8 are flow charts of an example method for forwarding data in from one DNIC and out another DNIC. For example, if system 100 were acting as a network router and data received at a network port of DNIC 110 was to be forwarded out another network port of DNIC 112. As shown, method 600 represents an egress port flow, method 700 represents an ingress port flow, and method 800 represents a processor configuration flow.

Software running on the host processor creates and configures forwarding tables (802). The forwarding tables contains a list of “incoming and outgoing ports” that are configured e.g. based on IP address. As an example, an entry in this table would specify that IP address X arriving from port Y, should go on port Z. The addresses of these forwarding tables are also configured on the DNICs (804). The DNICs selectively bring relevant contents from these addresses into the coherent cache, either on demand or based on speculation (806).

Data arrives at one of the MACs on a DNIC, called the receiving DNIC (702). First, the receiving DNIC puts the packet (706) into its coherent cache 206 or into an addressed buffer that was allocated for its use by the host, as part of initialization. The receiving DNIC parses the packet, and checks (704) against its cached forwarding table to determine if it already has an entry that describes the action to be performed with this packet. If so, and the action says the packet needs to be forwarded on port Z, for example, the receiving DNIC (110) does the following:

First, DNIC 110 requests ownership of the address of the next descriptor for port Z, via the coherency protocol over coherent bus 108.

DNIC 110 then creates (708) a descriptor with the address of its allocated buffer. The act of updating the descriptor would notify the coherency engine monitoring (602) the address. As an example if port Z happens to be on DNIC 112 (the sending DNIC), it is notified, by its coherency engine 204 if there is a write (604).

DNIC 112 then reads (606) the cache line associated with the descriptor, as well as the packet that the descriptor points to. This read could be further optimized to prevent memory writebacks, if desired.

DNIC 110 also monitors (710) the descriptor cache lines for completions, and as soon as it notices a completion (608), it retrieves the packet buffer that it had provided to the sending DNIC 112.

Thus, without any host SW intervention, not even device drivers, this data flow can continue to execute, for layer 2 forwarding. If the action in the forwarding table requires the host SW to perform some actions, the flow is slightly different. The host is notified of packet arrival in this case, and performs the necessary action, and then sends the packet back to the receiving DNIC, which then forwards to the sending DNIC, per the steps outlined above.

FIG. 9 is a block diagram of an example storage medium including content which, when accessed by a device, causes the device to implement one or more aspects of one or more embodiment(s) of the invention. In this regard, storage medium 900 includes content 902 (e.g., instructions, data, or any combination thereof) which, when executed, causes the system to implement one or more aspects of methods described above.

The machine-readable (storage) medium 900 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection)

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A network interface controller comprising:
a non-coherent bus interface to communicatively couple with devices of a system through a non-coherent protocol, the non-coherent bus interface to facilitate discovery of the network interface controller by an operating system;
a coherent bus interface to communicatively couple with devices of the system through a coherent protocol; and
a coherency engine to perform coherent transactions over the coherent interface including to snoop for writes on a system memory.

2. The network interface controller of claim 1, further comprising a coherent cache coupled with the coherent bus interface, the coherency engine to implement a cache coherency protocol for data stored in the coherent cache to be fully coherent with the system.

3. The network interface controller of claim 2, further comprising a backup data mover to backup data into a private memory when an application buffer is unavailable.

4. The network interface controller of claim 3, further comprising a plurality of network ports, the coherency engine to forward data received at a first network port out over a second network port without communicating with other devices of the system.

5. The network interface controller of claim 4, further comprising the coherency engine to monitor addresses in the system memory over the coherent bus interface for an indication of access by other agents on the coherent fabric.

6. The network interface controller of claim 4, further comprising the coherency engine to respond to data received over a network port by moving the data to a location in the system memory over the coherent bus interface.

7. A system comprising:
a processor;
a system memory to store data received over a coherent bus;
an input/output controller to interface the coherent bus with a non-coherent bus; and
a network interface controller comprising:
a non-coherent interface to communicatively couple with the input/output controller over the non-coherent bus;
a coherent interface to communicatively couple with the processor and the system memory over the coherent bus; and
a coherency engine to perform coherent transactions over the coherent interface including to snoop for writes to the system memory.

8. The system of claim 7, wherein the network interface controller further comprises a coherent cache coupled with the coherent bus interface, the coherency engine to implement a cache coherency protocol for data stored in the coherent cache to be fully coherent with the system.

9. The system of claim 7, wherein the network interface controller further comprises a backup data mover to backup data into a private memory when an application buffer is unavailable.

10. The system of claim 7, further comprising a second network interface controller, the first and second network interface controllers including a plurality of network ports, the coherency engines of the first and second network interface controllers to forward data received at a first network port of the first network interface controller out over a second network port of the second network interface controller without involving the system memory.

11. The system of claim 7, further comprising the coherency engine to monitor addresses in the system memory over the coherent bus interface for an indication to perform a transmit operation.

12. The system of claim 7, further comprising the coherency engine to respond to data received over a network port by moving the data to a location in the system memory over the coherent bus interface.

13. The system of claim 7, wherein the coherent bus comprises a QuickPath Interconnect bus.

14. The system of claim 7, wherein the non-coherent bus comprises a Peripheral Component Interconnect (PCI) Express bus.

15. A storage medium comprising content which, when executed by an accessing machine, causes the accessing machine to:
discover a network interface controller over a non-coherent bus during an operating system scan;
perform coherent data transfers with the network interface controller over a coherent bus;
monitor writes to addresses in a system memory associated with device registers of the network interface controller over the coherent bus; and
transfer data from the system memory to the network interface controller over the coherent bus.

16. The storage medium of claim 15, further comprising content which, when executed by an accessing machine, causes the accessing machine to implement a coherency protocol over the coherent bus on cache integrated within the network interface controller.

17. The storage medium of claim 15, further comprising content which, when executed by an accessing machine, causes the accessing machine to backup data from the network interface controller into a private memory when an application buffer is unavailable.

18. The storage medium of claim 15, further comprising content which, when executed by an accessing machine, causes the accessing machine to forward data received at a first network port of the network interface controller out over a second network port of the network interface controller without communicating with other devices of the system.

19. The storage medium of claim 15, further comprising content which, when executed by an accessing machine, causes the accessing machine to initiate a transmit operation within the network interface controller over the coherent bus in response to a predetermined change in the system memory.

20. The storage medium of claim 15, further comprising content which, when executed by an accessing machine, causes the accessing machine to respond to data received over a network port of the network interface controller by moving the data to a location in the system memory over the coherent bus.
